(19) United States
(12) Patent Application Publication
(10) Pub. No.: US 2026/0239077 A1
(43) Pub. Date: Aug. 13, 2026

(54) BEAM REPORTING BASED ON USER EQUIPMENT GROUPING

(71) Applicant: Google LLC, Mountain View, CA (US)

(72) Inventors: Yushu ZHANG, Beijing (CN); Jong-Kae FWU, Sunnyvale, CA (US)

(21) Appl. No.: 19/156,848

(22) PCT Filed: Feb. 17, 2023
(86) PCT No.: PCT/CN2023/076863

§ 371 Date: Aug. 14, 2025

(51) Int. Cl. H04W 24/10

(52) U.S. Cl. CPC H04W 24/10

(57) ABSTRACT

Systems, devices, apparatus, and methods, including computer programs encoded on storage media are described herein for beam reporting based on UE grouping. A UE (102) detects reference signals (312a-312n) enabling the UE (102) to assess a measured beam quality of one or more beams emitted by a network entity (104) and generates a request (316) for updating a grouping status of the UE (102) based on a comparison of the measured beam quality and a parameter associated with a UE group that provides, to the network entity (104), a single beam report (320) for UEs pertaining to the UE group. The UE (102) sends, to the network entity (104), the request (316).

### TECHNICAL FIELD

The present description relates generally to wireless communication, and more particularly, to beam reporting based on user equipment (UE) grouping.

### BACKGROUND

The Third Generation Partnership Project (3GPP) specifies a radio interface referred to as fifth generation (5G) new radio (NR) (5G NR). An architecture for a 5G NR wireless communication system includes a 5G core (5GC) network, a 5G radio access network (5G-RAN), a user equipment (UE), etc. The 5G NR architecture seeks to provide increased data rates, decreased latency, and/or increased capacity compared to prior generation cellular communication systems.

Wireless communication systems, in general, may be configured to provide various telecommunication services (e.g., telephony, video, data, messaging, broadcasts, etc.) based on multiple-access technologies, such as orthogonal frequency division multiple access (OFDMA) technologies, that support communication with multiple UEs. Improvements in mobile broadband continue the progression of such wireless communication technologies. For example, a UE can measure beams from a base station to select/identify a strongest beam for communicating with the base station. However, when multiple UEs are independently performing beam measurement and reporting to the base station, signaling overhead and power consumption costs may be high.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

A network entity (NE), such as a base station or a unit of a base station, may communicate with a user equipment (UE) using a beam among beams that the NE can emit. The NE may indicate a set of channel measurement resources (CMRs) to the UE for the UE to measure the NE's beams to select/identify one or more best beams from UE's perspective to be used by the NE for communicating with the UE. The UE may select/identify the beam(s) based on a measured quality of the beams in the beam set. The UE transmits a beam report to the network entity, the beam report indicating the measured beam quality of the best beam(s) to be used for communicating with the UE.

Conventionally, each UE in communication with the network entity independently performs beam measurement and reporting to the network entity. The network entity then informs the UE about the beam the network entity is going to use for upcoming communications, for example, by transmitting a transmission configuration indicator (TCI). However, a plurality of UEs (e.g., UEs that have a same or similar trajectory and orientation, such as UEs located inside a same vehicle) may have a same best network beam. Therefore, the plurality of UEs may form a UE group, the UEs in the UE group receiving communications from the NE via the same beam. In such cases, signaling overhead and power consumption for the UEs in the UE group can be reduced by having only one UE in the UE group performing the beam measurement and reporting.

The UE and/or the network entity may perform a UE group detection procedure to determine whether the UE should be grouped into the UE group. If the UE performs the UE group detection procedure, the UE may determine whether a measured beam quality or a change in a measured beam quality of reference signals received from another UE is less than/greater than a threshold. The UE may determine that the UE should leave the UE group if the measured beam quality is less than or equal to a threshold, or that the UE should join the UE group if the measured beam quality is greater than the threshold. The UE indicates the determination to the network entity (e.g., through a request to join/leave the UE group), such that the network entity may update a status of the UE relative to the UE group.

If the network entity performs the UE group detection procedure, the network entity may configure one or more UEs to report a measured beam quality to the network entity. The network entity compares the reported beam quality measurements to one or more parameters to determine whether a reported beam quality measurement is greater than/less than the threshold. The network entity may add or remove the UE from the UE group based on the UE group detection procedure.

According to some aspects, a UE detects reference signals enabling the UE to assess a measured beam quality of one or more beams emitted by a network entity and generates a request for updating a grouping status of the UE based on a comparison of the measured beam quality and a parameter associated with a UE group that provides, to the network entity, a single beam report for UEs pertaining to the UE group. The UE sends, to the network entity, the request.

According to some aspects, a network entity receives a measured beam report from a UE and updates a grouping status of the UE relative to a UE group based on the measured beam report. The network entity receives a single beam report for UEs in the UE group.

### BRIEF DESCRIPTION OF THE DRAWINGS

FIG. 1 illustrates a diagram of a wireless communications system that includes a plurality of user equipments (UEs) and network entities in communication over one or more cells.

FIG. 2A-2B illustrates diagrams for UE group-based beam reporting.

FIG. 3 illustrates a signaling diagram for a UE group beam report based on UE group detection by the UEs.

FIG. 4 illustrates a flowchart of a method of wireless communication at a UE for UE group detection by the UE.

FIG. 5 illustrates a flowchart of a method of wireless communication at a network entity for UE group detection by the UE.

FIG. 6 illustrates a signaling diagram for a UE group beam report based on UE group detection by the network entity and a measurement cycle.

FIG. 7 illustrates a flowchart of a method of wireless communication at a UE for UE group detection by a network entity.

FIG. 8 illustrates a flowchart of a method of wireless communication at a network entity for UE group detection by the network entity.

FIG. 9 is a flowchart of a method of wireless communication at a UE.

FIG. 10 is a flowchart of a method of wireless communication at a network entity.

FIG. 11 is a diagram illustrating a hardware implementation for an example UE apparatus.

FIG. 12 is a diagram illustrating a hardware implementation for one or more example network entities.

### DETAILED DESCRIPTION

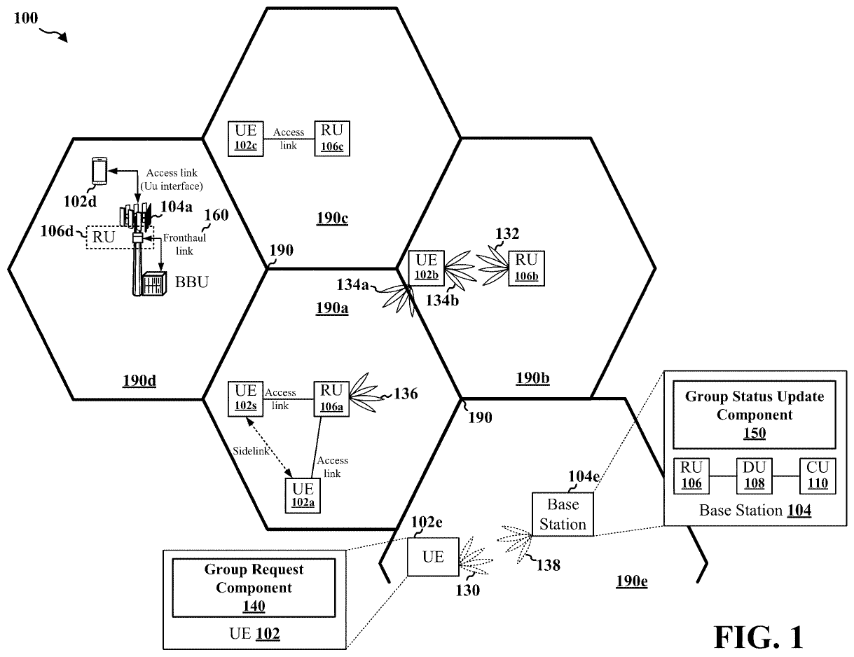

FIG. 1 illustrates a diagram 100 of a wireless communications system associated with a plurality of cells 190. The wireless communications system includes user equipments (UEs) 102 and base stations/network entities 104. Some base stations may include an aggregated base station architecture and other base stations may include a disaggregated base station architecture. The aggregated base station architecture includes a radio unit (RU) 106, a distributed unit (DU) 108, and a centralized unit (CU) 110 that are configured to utilize a radio protocol stack that is physically or logically integrated within a single radio access network (RAN) node. A disaggregated base station architecture utilizes a protocol stack that is physically or logically distributed among two or more units (e.g., RUs 106, DUs 108, CUs 110). For example, a CU 110 is implemented within a RAN node, and one or more DUs 108 may be co-located with the CU 110, or alternatively, may be geographically or virtually distributed throughout one or multiple other RAN nodes. The DUs 108 may be implemented to communicate with one or more RUs 106. Each of the RU 106, the DU 108 and the CU 110 can be implemented as virtual units, such as a virtual radio unit (VRU), a virtual distributed unit (VDU), or a virtual central unit (VCU). The base station/network entity 104 (e.g., an aggregated base station or disaggregated units of the base station, such as the RU 106, the DU 108, or the CU 110), may be referred to as a transmission reception point (TRP).

Operations of the base station 104 and/or network designs may be based on aggregation characteristics of base station functionality. For example, disaggregated base station architectures are utilized in an integrated access backhaul (IAB) network, an open-radio access network (O-RAN) network, or a virtualized radio access network (vRAN), which may also be referred to a cloud radio access network (C-RAN). Disaggregation may include distributing functionality across the two or more units at various physical locations, as well as distributing functionality for at least one unit virtually, which can enable flexibility in network designs. The various units of the disaggregated base station architecture, or the disaggregated RAN architecture, can be configured for wired or wireless communication with at least one other unit. For example, the base stations 104a/104e and/or the RUs 106a, 106b, 106c, 106d may communicate with the UEs 102a, 102b, 102c, 102d, and 102s via one or more radio frequency (RF) access links based on a Uu interface. In examples, multiple RUs 106 and/or base stations 104 may simultaneously serve the UEs 102, such as by intra-cell and/or inter-cell access links between the UEs 102 and the RUs 106/base stations 104.

The RU 106, the DU 108, and the CU 110 may include (or may be coupled to) one or more interfaces configured to transmit or receive information/signals via a wired or wireless transmission medium. A base station 104 or any of the one or more disaggregated base station units can be configured to communicate with one or more other base stations 104 or one or more other disaggregated base station units via the wired or wireless transmission medium. In examples, a processor, a memory, and/or a controller associated with executable instructions for the interfaces can be configured to provide communication between the base stations 104 and/or the one or more disaggregated base station units via the wired or wireless transmission medium. For example, a wired interface can be configured to transmit or receive the information/signals over a wired transmission medium, such as via the fronthaul link 160 between the RU 106d and the baseband unit (BBU) 112 of the base station 104d associated with the cell 190d. The BBU 112 includes a DU 108 and a CU 110, which may also have a wired interface (e.g., midhaul link) configured between the DU 108 and the CU 110 to transmit or receive the information/signals between the DU 108d and the CU 110d. In further examples, a wireless interface, which may include a receiver, a transmitter, or a transceiver, such as an RF transceiver, configured to transmit and/or receive the information/signals via the wireless transmission medium, such as for information communicated between the RU 106a of the cell 190a and the base station 104e of the cell 190e via cross-cell communication beams 136-138 of the RU 106a and the base station 104e.

The RUs 106 may be configured to implement lower layer functionality. For example, the RU 106 is controlled by the DU 108 and may correspond to a logical node that hosts RF processing functions, or lower layer PHY functionality, such as execution of fast Fourier transform (FFT), inverse FFT (iFFT), digital beamforming, physical random access channel (PRACH) extraction and filtering, etc. The functionality of the RU 106 may be based on the functional split, such as a functional split of lower layers.

The RUs 106, such as the RU 106c of the cell 190c, may communicate with the UEs 102, such as the UE 102c, via an access link or via over-the-air (OTA) communication with one or more UEs 102. For example, the RU 106b of the cell 190b communicates with the UE 102b of the cell 190b via a first set of communication beams 132 of the RU 106b and a second set of communication beams 134b of the UE 102b, which may correspond to inter-cell communication beams or, in some examples, cross-cell communication beams. For instance, the UE 102b of the cell 190b may communicate with the RU 106a of the cell 190a via a third set of communication beams 134a of the UE 102b and a fourth set of communication beams 136 of the RU 106a. Both real-time and non-real-time features of control plane and user plane communications of the RUs 106 can be controlled by associated DUs 108.

Any combination of the RU 106, the DU 108, and the CU 110, or reference thereto individually, may correspond to a base station 104. Thus, the base station 104 may include at least one of the RU 106, the DU 108, or the CU 110. The base stations 104 provide the UEs 102 with access to a core network. The base stations 104 might relay communications between the UEs 102 and the core network. The base stations 104 may be associated with macrocells for high-power cellular base stations and/or small cells for low-power cellular base stations. For example, the cell 190e may correspond to a macrocell, whereas the cells 190a-190d may correspond to small cells. Small cells include femtocells, picocells, microcells, etc. A cell structure that includes at least one macrocell and at least one small cell may be referred to as a “heterogeneous network.”

Transmissions from a UE 102 to a base station 104/RU 106 are referred to as uplink (UL) transmissions, whereas transmissions from the base station 104/RU 106 to the UE 102 are referred to as downlink (DL) transmissions. Uplink transmissions may also be referred to as reverse link transmissions and downlink transmissions may also be referred to as forward link transmissions. For example, the RU 106d utilizes antennas of the base station 104d of cell 190d to transmit a downlink/forward link communication to the UE 102d or receive an uplink/reverse link communication from the UE 102d based on the Uu interface associated with the access link between the UE 102d and the base station 104d/RU 106d.

Communication links between the UEs 102 and the base stations 104/RUs 106 may be based on multiple-input and multiple-output (MIMO) antenna technology, including spatial multiplexing, beamforming, and/or transmit diversity. The communication links may be associated with one or more carriers. The UEs 102 and the base stations 104/RUs 106 may utilize a spectrum bandwidth of Y MHz (e.g., 5, 10, 15, 20, 100, 400, 800, 1600, 2000, etc. MHz) per carrier allocated in a carrier aggregation of up to a total of Yx MHz, where x component carriers (CCs) are used for communication in each of the uplink and downlink directions. The carriers may or may not be adjacent to each other along a frequency spectrum. In examples, uplink and downlink carriers may be allocated in an asymmetric manner, more or fewer carriers may be allocated to either the uplink or the downlink. A primary component carrier and one or more secondary component carriers may be included in the component carriers. The primary component carrier may be associated with a primary cell (PCell) and a secondary component carrier may be associated with as a secondary cell (SCell).

Some UEs 102, such as the UEs 102a and 102s, may perform device-to-device (D2D) communications over sidelink. For example, a sidelink communication/D2D link utilizes a spectrum for a wireless wide area network (WWAN) associated with uplink and downlink communications. The sidelink communication/D2D link may also use one or more sidelink channels, such as a physical sidelink broadcast channel (PSBCH), a physical sidelink discovery channel (PSDCH), a physical sidelink shared channel (PSSCH), and/or a physical sidelink control channel (PSCCH), to communicate information between UEs 102a and 102s. Such sidelink/D2D communication may be performed through various wireless communications systems, such as wireless fidelity (Wi-Fi) systems, Bluetooth systems, Long Term Evolution (LTE) systems, New Radio (NR) systems, etc.

The electromagnetic spectrum is often subdivided into different classes, bands, channels, etc., based on different frequencies/wavelengths associated with the electromagnetic spectrum. Fifth-generation (5G) NR is generally associated with two operating frequency ranges (FRs) referred to as frequency range 1 (FR1) and frequency range 2 (FR2). FR1 ranges from 410 MHz-7.125 GHz and FR2 ranges from 24.25 GHz-71.0 GHz, which includes FR2-1 (24.25 GHz-52.6 GHZ) and FR2-2 (52.6 GHz-71.0 GHz). Although a portion of FR1 is actually greater than 6 GHz, FR1 is often referred to as the “sub-6 GHz” band. In contrast, FR2 is often referred to as the “millimeter wave” (mmW) band. FR2 is different from, but a near subset of, the “extremely high frequency” (EHF) band, which ranges from 30 GHz-300 GHz and is sometimes also referred to as a “millimeter wave” band. Frequencies between FR1 and FR2 are often referred to as “mid-band” frequencies. The operating band for the mid-band frequencies may be referred to as frequency range 3 (FR3), which ranges 7.125 GHZ-24.25 GHz. Frequency bands within FR 3 may include characteristics of FR1 and/or FR2. Hence, features of FR1 and/or FR2 may be extended into the mid-band frequencies. Higher operating frequency bands have been identified to extend 5G NR communications above 52.6 GHz associated with the upper limit of FR2. Three of these higher operating frequency bands include FR2-2, which ranges from 52.6 GHz-71.0 GHz, FR4, which ranges from 71.0 GHz-114.25 GHz, and FR5, which ranges from 114.25 GHz-300 GHz. The upper limit of FR5 corresponds to the upper limit of the EHF band. Thus, unless otherwise specifically stated herein, the term “sub-6 GHz” may refer to frequencies that are less than 6 GHZ, within FR1, or may include the mid-band frequencies. Further, unless otherwise specifically stated herein, the term “millimeter wave”, or mmW, refers to frequencies that may include the mid-band frequencies, may be within FR2-1, FR4, FR2-2, and/or FR5, or may be within the EHF band.

The UEs 102 and the base stations 104/RUs 106 may each include a plurality of antennas. The plurality of antennas may correspond to antenna elements, antenna panels, and/or antenna arrays that may facilitate beamforming operations. For example, the RU 106b transmits a downlink beamformed signal based on a first set of communication beams 132 to the UE 102b in one or more transmit directions of the RU 106b. The UE 102b may receive the downlink beamformed signal based on a second set of communication beams 134b from the RU 106b in one or more receive directions of the UE 102b. In a further example, the UE 102b may also transmit an uplink beamformed signal to the RU 106b based on the second set of communication beams 134b in one or more transmit directions of the UE 102b. The RU 106b may receive the uplink beamformed signal from the UE 102b in one or more receive directions of the RU 106b.

The UE 102b may perform beam training to determine the best receive and transmit directions for the beamformed signals. The transmit and receive directions for the UEs 102 and the base stations 104/RUs 106 might or might not be the same. In further examples, beamformed signals may be communicated between a first base station/RU 106a and a second base station 104e. For instance, the base station 104e of the cell 190e may transmit a beamformed signal to the RU 106a based on the communication beams 138 in one or more transmit directions of the base station 104e. The RU 106a may receive the beamformed signal from the base station 104e of the cell 190e based on the RU communication beams 136 in one or more receive directions of the RU 106a. In further examples, the base station 104e transmits a downlink beamformed signal to the UE 102e based on the communication beams 138 in one or more transmit directions of the base station 104e. The UE 102e receives the downlink beamformed signal from the base station 104e based on UE communication beams 130 in one or more receive directions of the UE 102e. The UE 102e may also transmit an uplink beamformed signal to the base station 104e based on the UE communication beams 130 in one or more transmit directions of the UE 102e, such that the base station 104e may receive the uplink beamformed signal from the UE 102e in one or more receive directions of the base station 104e.

The base station 104 may include and/or be referred to as a network entity. That is, “network entity” may refer to the base station 104 or at least one unit of the base station 104, such as the RU 106, the DU 108, and/or the CU 110. The base station 104 may also include and/or be referred to as a next generation evolved Node B (ng-eNB), a generation NB (gNB), an evolved NB (eNB), an access point, a base transceiver station, a radio base station, a radio transceiver, a transceiver function, a basic service set (BSS), an extended service set (ESS), a TRP, a network node, network equipment, or other related terminology. The base station 104 or an entity at the base station 104 can be implemented as an IAB node, a relay node, a sidelink node, an aggregated (monolithic) base station with an RU 106 and a BBU 112 that includes a DU 108 and a CU 110, or as a disaggregated base station including one or more RUs 106, DUs 108, and/or CUs 110. A set of aggregated or disaggregated base stations may be referred to as a next generation-radio access network (NG-RAN). In some examples, the UE 102a operates in dual connectivity (DC) with the base station 104e and the base station/RU 106a. In such cases, the base station 104e can be a master node and the base station/RU 160a can be a secondary node.

Still referring to FIG. 1, in certain aspects, any of the UEs 102 may include a group request component 140 configured to detect reference signals enabling to assess a measured beam quality of one or more beams emitted by a network entity; generate a request for updating a grouping status of the UE based on a comparison of the measured beam quality and a parameter associated with a UE group that provides a single beam report for UEs pertaining to the UE group, to the network entity; and send, to the network entity, the request. The grouping status indicates whether a UE pertains to the UE group.

In certain aspects, any of the base stations 104 or a network entity of the base stations 104 may include a group status update component 150 configured to receive a measured beam report from a UE; and update a grouping status of the UE relative to a UE group based on the measured beam report, the network entity receiving a single beam report for UEs in the UE group.

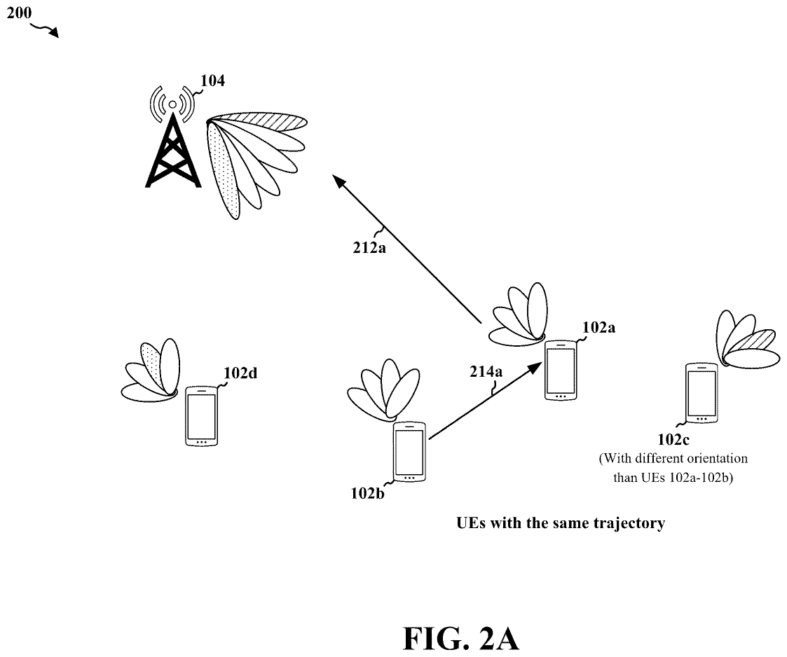

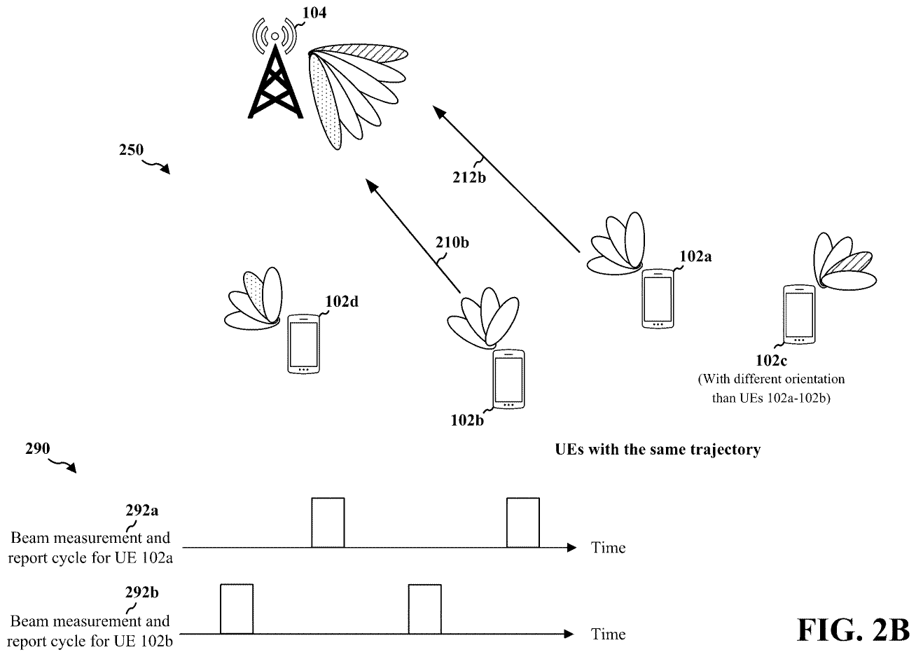

Accordingly, FIG. 1 describes a wireless communication system that may be implemented in connection with aspects of one or more other figures described herein, such as aspects illustrated in FIGS. 2A-2B. Further, although the following description may be focused on 5G NR, the concepts described herein may be applicable to other similar areas, such as 5G-Advanced and future versions, LTE, LTE-advanced (LTE-A), and other wireless technologies, such as 6G.

FIGS. 2A-2B illustrates diagrams 200 and 250-290 for UE group-based beam reporting. A cell radius/coverage area of a network entity 104, such as a base station, may be based on a link budget. The “link budget” refers to an accumulation of total gains and losses in a system, which provide a received signal level at a receiver, such as a UE 102. The receiver may compare the received signal level to a receiver sensitivity to determine whether a channel provides at least a minimum signal strength for signals communicated between the receiver and a transmitter (e.g., the UEs 102 and the network entity 104).

In order to increase the link budget, the network entity 104 and the UEs 102 may perform an analog beamforming operation to activate a beam pair having an increased signal strength. Both the network entity 104 and the UEs 102 maintain a plurality of beams that may be used for the beam pair. A beam pair that decreases a coupling loss may result in an increased coverage gain for the network entity 104 and the UEs 102. “Coupling loss” refers to a path loss/reduction in power density between a first antenna of a network entity 104 and a second antenna of a UE 102 and may be indicated in units of decibel (dB). Beam selection procedures for the beam pair activated by the network entity 104 and the UEs 102 may be associated with one or more of beam measurement operations, beam measurement reporting, or Conventional beam reporting procedures have been UE-specific. That is, each UE 102 in communication with the network entity 104 performs an independent beam measurement and report procedure with the network entity 104. The network entity 104 may then select a beam for a UE 102 via transmission configuration indicator (TCI) update signaling. However, some UEs 102a, 102b, 102c may share a same or similar trajectory. For example, the UEs 102a, 102b, 102c may be inside a same vehicle and may be in close proximity to each other. Hence, a best (e.g., strongest) network beam for the UEs 102a, 102b, 102c could be the same, if the UEs 102a, 102b, 102c also have a same orientation. That is, as a result of directional antennas being included in the UEs 102, the best/strongest network beams may be different for the UEs 102a, 102b, 102c, even though the UEs 102a, 102b, 102c share the same or similar trajectory, when their orientations are different. For example, the UE 102a, 102b, 102c may be in a same car/vehicle and, thus, share the same trajectory. However, the UE 102c has a different orientation than the UEs 102a-102b. In further examples, another UE 102d is located outside the car/vehicle and, therefore, has a different trajectory than the UEs 102a-102c that are located within the car/vehicle.

The UEs 102a-102b that share both the same trajectory and orientation may utilize a common network beam for communicating with the network entity 104. Accordingly, the UEs 102a-102b do not have to perform independent beam measurement and reporting procedures with the network entity 104, as one of the UEs 102a-102b can perform beam measurement and reporting for both of the UEs 102a-102b, which may be regarded as a UE group. Independent beam measurements and reports by the UEs 102a-102b results in increased overhead and UE power consumption at a UE (e.g., UE 102b) that could otherwise refrain from performing the measuring and reporting when included in a UE group with a group leader UE that performs the measuring and reporting for the whole UE group.

Before a UE 102 can measure and report a beam quality for an entire UE group, the UE 102 may have to determine whether other UEs of the UE group have, or are expected to have, a same or similar trajectory and orientation as the UE 102 that is performing the measuring and reporting to the network entity 104 or, more specifically, whether other UEs of the UE group have, or are expected to have, a same best/strongest network beam. Hence, a UE-group monitoring procedure may be implemented to determine whether the other UEs are part of a beam report group with the measuring/reporting UE.

In a first example, as illustrated in the diagram 200 of FIG. 2A, the beam report for the UE group is implemented based on UE group detection by the UEs 102a-102b. The second UE 102b transmits 214a a reference signal to the first UE 102a, such that the first UE 102a can determine a beam quality change among the UEs 102a-102b. The reference signal may be a sounding reference signal (SRS) or a channel state information-reference signal (CSI-RS). Based on the beam quality change indicated via the reference signal that the first UE 102a receives 214a from the second UE 102b, the first UE 102a can determine whether to join or leave the UE group. The first UE 102a may transmit 212a a beam report to the network entity 104 that indicates a status of the first UE 102a with respect to the UE group.

In a second example, as illustrated in the diagrams 250-290 of FIG. 2B, the beam report for the UE group is implemented based on UE group detection by the network entity 104 and a measurement cycle. The network entity 104 may configure the first UE 102a and the second UE 102b to transmit 210b/212b beam reports for UE-group detection. Referring to the diagram 290, the network entity 104 may configure or update beam measurement and report cycles 292a-292b, such as a discontinuous reception (DRX) for measurement (DRX-M), for the UEs 102a-102b. The UEs 102a-102b perform beam measurement and reporting when the DRX-M is in an “ON” state and do not perform the beam measurement and reporting when the DRX-M is in an “OFF” state. The network entity 104 may update a beam report periodicity for a beam report configuration for periodic or semi-persistent beam reports. In examples, the network entity 104 indicates the updated periodicity, or periodicity and slot offset, for a beam report configuration for periodic or semi-persistent beam reports by a medium access control-control element (MAC-CE) or downlink control information (DCI). The network entity 104 may also activate or deactivate the beam report configuration. In examples, the network entity 104 activates or deactivates the beam report configuration by the MAC CE or DCI.

The network entity 104 may semi-statically or dynamically configure/indicate one of the first UE 102a or the second UE 102b to transmit the beam report and the other UE to perform UE group detection. The network entity 104 may transmit radio resource control (RRC) signaling or a MAC-CE for the semi-static configuration of a UE 102 within the UE group, or the network entity 104 may transmit DCI for dynamic configuration of the UE 102 within the UE group. The UE group can include more than two UEs, in some examples.

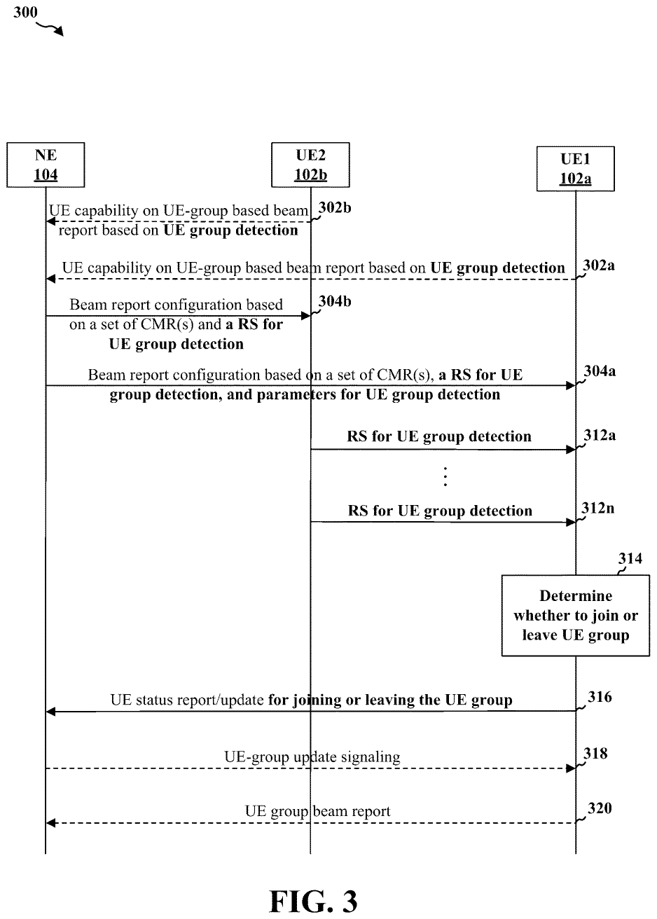

UE group-based beam reports may reduce signaling overhead and power consumption by the UEs 102. Transmitting a single UE group-based beam report for all the UEs in the UE group reduces the beam reporting overhead for the other UEs in the UE group, which may improve an overall system performance. The UEs of the UE group that do not send/transmit a beam report may experience a power savings as a result of power that would otherwise be consumed for independent beam measurement and reporting by the UEs 102. FIGS. 2A-2B illustrate example techniques for sending, to the network entity, a beam report for a group of UEs, whereas FIG. 3 illustrates signaling procedures to perform the example techniques described with respect to FIGS. 2A-2B.

FIG. 3 illustrates a signaling diagram 300 for a UE group beam report based on UE group detection by the UEs 102a-102b. The first UE 102a and the second UE 102b may report 302a-302b, to the network entity 104, a UE capability for a UE group-based beam report based on UE group detection by the UEs 102a-102b. In other implementations, the network entity 104 may receive the UE capability of the first UE 102a and/or the second UE 102b from a core network (e.g., an Access and Mobility Management Function (AMF)) or from a second network entity.

The UE capability may indicate whether the first UE 102a and/or the second UE 102b supports UE-group beam reports based on UE group detection. The UEs 102a-102b may indicate, within the UE capability report, a maximum number of configured reference signals (RSs) for UE the group detection, which may include a maximum number of reference signals in a slot for the UE group detection. The number of reference signals may be counted per component carrier (CC), per band, per band combination, or per UE.

The network entity 104 transmits 304a-304b, to the first UE 102a and the second UE 102b, control signaling for a beam report configuration (e.g., channel state information (CSI)-ReportConfig) based on a set of channel measurement resources (CMRs). The control signaling transmitted 304b to the second UE 102b may indicate a reference signal configured for UE group detection. The control signaling transmitted 304a to the first UE 102a may indicate a reference signal configured for UE group detection and parameters for the UE group detection. The parameters for the UE group detection may correspond to a threshold for the first UE 102a to determine 314 whether to join or leave the UE group. Threshold(s) for joining or leaving the UE group may be predefined or configured to the UE 102a by the network entity 104, where a first threshold may be for joining the UE group and a second threshold may be for leaving the UE group.

The control signaling may configure a first counter N1 for leaving the UE group, a second counter N2 for joining the UE group, and a UE group detection interval T. The first UE 102a may perform the UE group detection every T slots/ms. If the number of consecutively detected negative UE grouping instances is greater than N1, the first UE 102a may determine to leave the UE group. If the number of consecutively detected positive UE grouping instances is greater than N2, the first UE 102a may determine to join the UE group. In some examples, parameters such as N1=1 and/or N2=2 may be predefined for the first UE 102a.

The first UE 102a, or a group of UEs, measure a beam quality (e.g., layer 1-reference signal received power (L1-RSRP)) of one or more configured reference signals transmitted 312a-312n by the second UE 102b for the UE group detection. Within the UE group detection interval, the first UE 102a may detect a measured beam quality change of the configured one or more reference signals for the UE group detection. If the beam quality change is greater than the first threshold, the first UE 102a counts a negative UE grouping instance. If the beam quality change is less than the second threshold, the first UE 102a counts a positive UE grouping instance. If the number of consecutively detected negative UE grouping instances is greater than a first count of N1 for leaving the UE group, the first UE 102a determines 314 to leave the UE group. If the number of consecutively detected positive UE grouping instances is greater than a second count of N2 for joining the UE group, the first UE 102a determines 314 to join the UE group.

In some implementations, if the minimum, maximum, or average beam quality change of the configured reference signals is greater than the first threshold, the first UE 102a counts a negative UE grouping instance. If the minimum, maximum, or average beam quality change of the configured reference signals is less than or equal to the second threshold, the first UE 102a counts a positive UE grouping instance. Alternatively, the first UE 102a may report the measured L1-RSRP to the network entity 104 via physical uplink control channel (PUCCH) or physical uplink shared channel (PUSCH), such that the network entity 104 can determine the UE grouping status. UE grouping status refers to a relationship of the UE(s) 102 relative to the UE group. For instance, a first UE grouping status may be that the first UE 102a is currently within the UE group, or currently requests to be within/join the UE group, whereas a second UE grouping status may be that the first UE 102a is currently outside of the UE group, or currently requests to be outside of/leave the UE group. In other implementations, a third UE grouping status may include the first UE 102a determining/requesting to maintain a current status relative to the UE group (e.g., maintaining a current status within or outside of the UE group).

The network entity 104 may transmit 304a-304b the configuration to the first UE 102a and the second UE 102b through RRC signaling. The RRC signaling may indicate an RRCReconfiguration message from network entity 104 to the UEs 102a-102b or a system information block (SIB), where the SIB may be a traditional type of SIB (e.g., SIB1) or a different SIB (e.g., SIB J, where J corresponds to an integer greater than 21) transmitted by the network entity 104. The RRC signaling may further include the CSI-ReportConfig. The RRC signaling can indicate a set of CMRs for a beam measurement and at least one reference signal for the UE group detection. In some implementations, the reference signal may correspond to an SRS resource or an SRS resource set configured for the UE group detection. In other implementations, the reference signal may correspond to an SRS resource or an SRS resource set configured for codebook or antenna switching.

The second UE 102b transmits 312a-312n, to the first UE 102a, the one or more reference signals for the UE group detection. The first UE 102a receive 312a-312n the one or more reference signals and performs the UE group detection based on the parameters configured in the control signaling received 304 from the network entity 104. Based on the one or more reference signals received 312a-312n from the second UE 102b, the first UE 102a determines 314 whether to join or leave a UE group that includes the second UE 102b. In other implementations the signaling may be reversed, such that the first UE 102a transmits the one or more reference signals to the second UE 102b for the second UE 102b to determine whether to join or leave a UE group with the first UE 102a.

Responsive to the determination 314, the first UE 102a transmits 316 a UE status report/update to the network entity 104 for joining or leaving the UE group. In some examples, the UE status report/update may indicate that the first UE 102a has determined to remain within the UE group or remain outside the UE group. The configuration may include an indicator that enables the first UE 102a to determine whether to transmit 316 the UE status report/update to the network entity 104. For example, the first UE 102a may refrain from transmitting 316 the UE status report/update to the network entity 104 if the UE determines to remain within, or remain outside of, the UE group (i.e., not join or leave the UE group, but instead maintain a current status of the first UE 102a relative to the UE group). Otherwise, the first UE 102a may transmit 316 the UE status report/update if the first UE 102 determines 314 to join or leave the UE group.

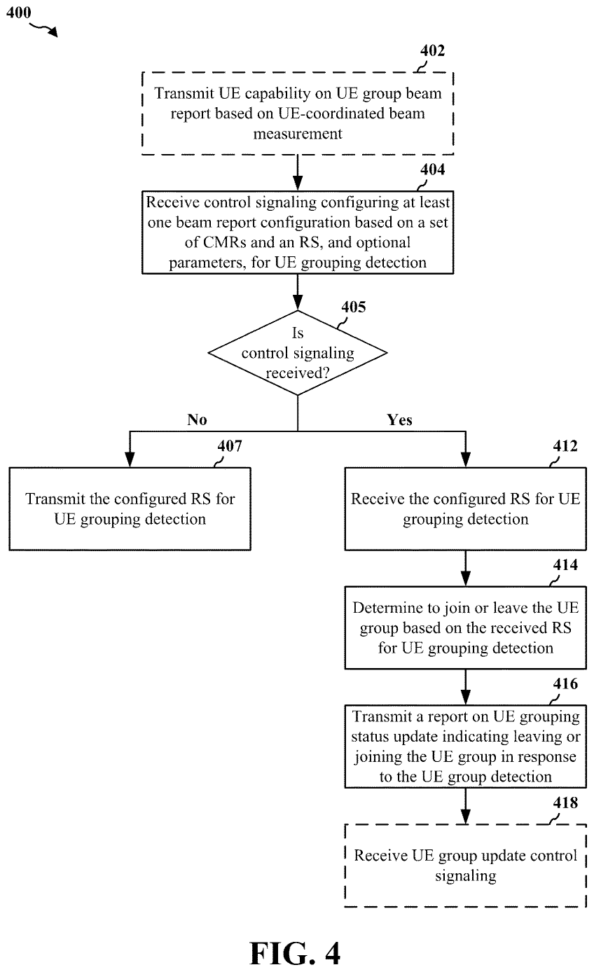

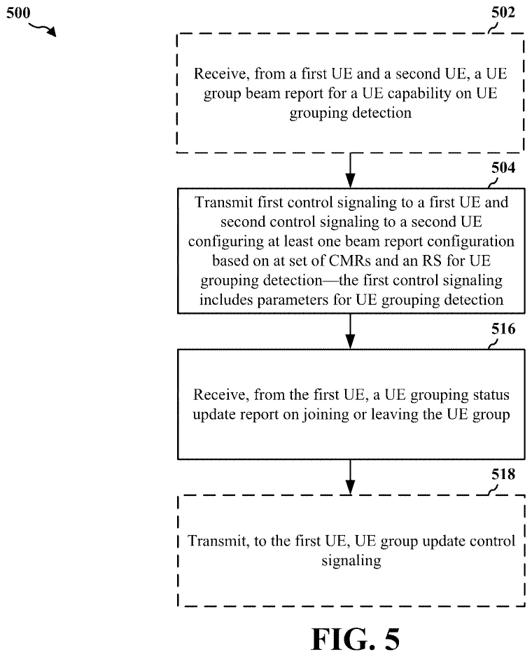

The network entity 104 may transmit 318 UE group update signaling to the first UE 102a to update the status of the first UE 102a relative to the UE group (e.g., the joining or leaving of the first UE 102a to/from the UE group). The network entity 104 may transmit 318 the UE group update signaling by RRC signaling, MAC-CE, or DCI. In some examples, the network entity 104 may notify other UEs of the UE group that the first UE 102a has joined or left the UE group. In other examples, the first UE 102 may notify the other UEs in the UE group that the first UE 102 has joined the UE group or is leaving the UE group. If the first UE 102a joins the UE group, or if the first UE 102a is already in the UE group and determines to remain in the UE group, the first UE 102a can transmit 320, to the network entity 104, the UE group-based beam report that includes information for the whole UE group. FIG. 3 described UE group detection by the UE 102, whereas FIGS. 4-5 show methods for implementing one or more aspects of FIG. 3. In particular, FIG. 4 shows an implementation by the UE 102 of the one or more aspects of FIG. 3. FIG. 5 shows an implementation by the network entity 104 of the one or more aspects of FIG. 3.

FIG. 4 illustrates a flowchart 400 of a method of wireless communication at a UE 102. For example, the UE 102 transmits 402 a UE capability on UE group beam report based on UE-coordinated beam measurement. Referring to FIG. 3, the UEs 102a-102b indicate 302a-302b, to the network entity 104, a UE capability on UE group-based beam report based on UE group detection.

The UE 102 receives 404 control signaling configuring at least one beam report configuration based on a set of CMRs and an RS, and optional parameters, for UE grouping detection. For example, referring to FIG. 3, the second UE 102b receives 304b, from the network entity 104, a beam report configuration based on a set of CMRs and a reference signal for UE group detection, and the first UE 102a receives 304a, from the network entity 104, the beam report configuration based on the set of CMRs, the reference signal for UE group detection, and parameters for UE group detection.

The UE 102 determines 405 whether the control signaling is received from the network entity 104. If the control signaling is not received from the network entity 104, the UE transmits 407 the configured RS for UE grouping. If the control signaling is received from the network entity 104, the UE 102 receives 412 the configured RS for UE grouping detection. For example, referring to FIG. 3, the first UE 102a receives 312a-312n one or more reference signals from the second UE 102b for UE group detection.

The UE 102 determines 414 to join or leave the UE group based on the received RS for UE grouping detection. For example, referring to FIG. 3, the first UE 102a determines 314 whether to join or leave the UE group based on measurement(s) of the one or more reference signals received 312a-312n from the second UE 102b.

The UE 102 transmits 416 a report on UE grouping status update indicating leaving or joining the UE group in response to the UE group detection. For example, referring to FIG. 3, the first UE 102a transmits 316, to the network entity 104, a UE status report/update for joining or leaving the UE group.

The UE 102 receives 418 UE group update control signaling. For example, referring to FIG. 3, the first UE 102a receives 318 UE group update signaling from the network entity 104. FIG. 4 describes a method from a UE-side of a wireless communication link, whereas FIG. 5 describes a method from a network-side of the wireless communication link.

FIG. 5 illustrates a flowchart 500 of a method of wireless communication at a network entity 104. For example, the network entity 104 receives 502, from a first UE and a second UE, a UE group beam report for a UE capability on UE grouping detection. Referring to FIG. 3, the network entity 104 receives 302a-302b, from the first UE 102a and the second UE 102b, a UE capability on UE group-based beam report based on UE group detection.

The network entity 104 transmits 504 first control signaling to a first UE and second control signaling to a second UE configuring at least one beam report configuration based on at set of CMRs and an RS for UE grouping detection-the first control signaling includes parameters for UE grouping detection. For example, referring to FIG. 3, the network entity 104 transmits 304b, to the second UE 102b, a beam report configuration based on a set of CMRs and a reference signal for UE group detection, and transmits 304a, to the first UE 102a, the beam report configuration based on the set of CMRs, the reference signal for UE group detection, and parameters for UE group detection.

The network entity 104 receives 516, from the first UE, a UE grouping status update report on joining or leaving the UE group. For example, referring to FIG. 3, the network entity 104 receives 316, from the first UE 102a, a UE status report/update for joining or leaving the UE group.

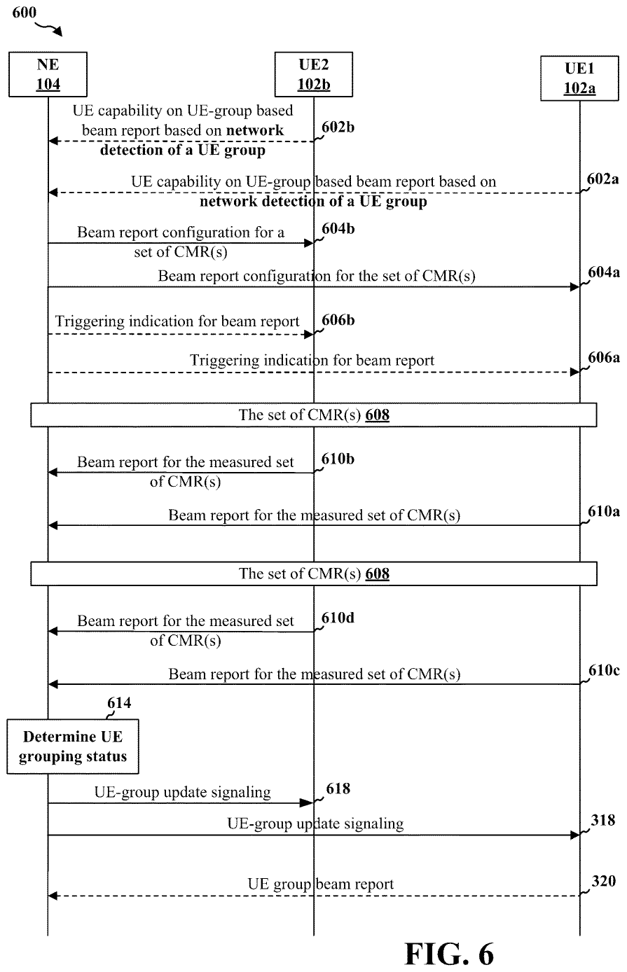

The network entity 104 transmits 518, to the first UE, UE group update control signaling. For example, referring to FIG. 3, the network entity 104 transmits 318 UE group update signaling to the first UE 102a. FIGS. 3-5 describe UE group detection by the UE 102, whereas FIGS. 6-8 describes UE group detection by the network entity 104.

FIG. 6 illustrates a signaling diagram 600 for a UE group beam report based on UE group detection by the network entity 104 and a measurement cycle. The first UE 102a and the second UE 102b may report 602a-602b, to the network entity 104, a UE capability for a UE group-based beam report based on network detection of a UE group. The UE capability signaling may indicate a capability of the UEs 102a-102b for a measurement cycle configuration, such as a configuration for DRX-M and supported DRX-M ON/OFF durations. The UE capability signaling may also indicate whether the UEs 102a-102b support dynamic updates to the periodicity for periodic or semi-persistent beam reports (e.g., MAC-CE or DCI based periodicity updates for periodic or semi-persistent beam reports).

The network entity 104 transmits 604a-604b control signaling to the first UE 102a and the second UE 102b for a beam report configuration (e.g., CSI-ReportConfig) for a set of CMRs 608. In some implementations, the network entity 104 may transmit 606a-606b triggering indication(s) to the first UE 102a and the second UE 102b for beam reports based on the set of CMRs 608. The triggering indication(s) may be transmitted 606a-606b through control signaling via MAC-CE or DCI. For example, the network entity 104 triggers 606a-606b a semi-persistent beam report through the MAC-CE and triggers 606a-606b an aperiodic beam report through the DCI.

The first UE 102a and the second UE 102b transmit 610a-610b a first set of beam reports to the network entity 104 based on respective first measurements for the set of CMRs 608. The first UE 102a and the second UE 102b may transmit multiple beam reports to the network entity 104 for the set of CMRs 608 (e.g., based on periodic, semi-persistent, or aperiodic reporting techniques). For example, the first UE 102a and the second UE 102b transmit 610c-610d a second set of beam reports to the network entity 104 based on respective second measurements for the set of CMRs 608.

The network entity 104 performs UE group detection based on the beam reports received 610a-610d from the UEs 102a-102b. That is, the network entity 104 determines 614 a UE grouping status of the first UE 102a and the second UE 102b. For example, the network entity applies thresholds similar to the UE-side thresholds described with respect to FIG. 3 for determining whether the UEs 102a-102b should be joined, disjoined, or maintained relative to the UE group.

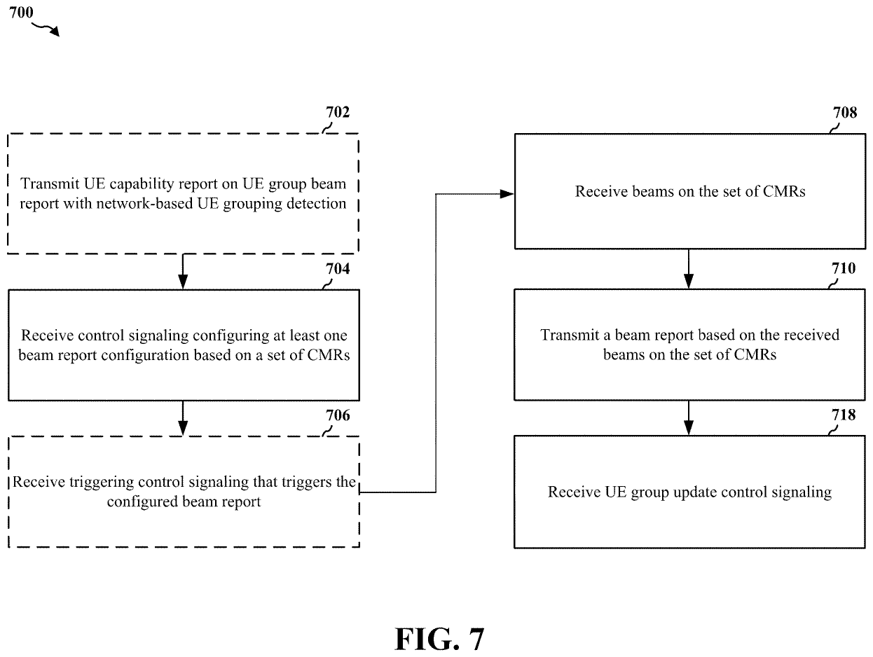

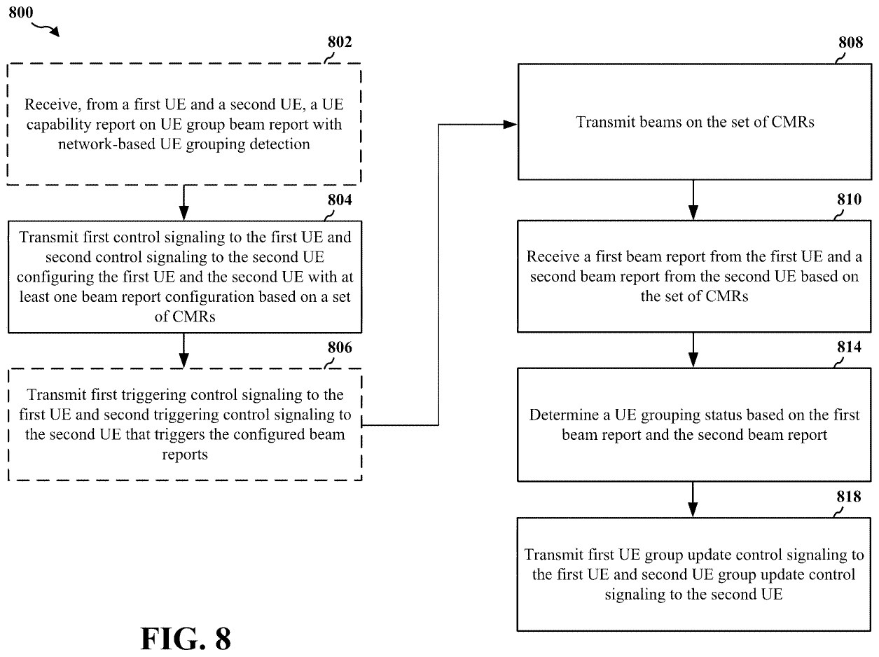

In response to determining 614 the UE grouping status of the UEs 102a-102b, the network entity 104 transmits 318/618 the UE group update signaling to the UEs 102a-102b that indicates the determined UE grouping status of the UEs 102a-102b. The network entity 104 may transmit 318/618 the UE group update signaling by RRC signaling, MAC-CE, or DCI. In examples, the network entity 104 uses the UE group update signaling to configure a measurement cycle for one or more beam report configurations (e.g., DRX-M ON/OFF durations and offsets), update the periodicity for periodic or semi-persistent beam reports, and/or activate/deactivate one or more beam report configurations. Depending on whether the first UE 102a or the second UE 102b is the leader of the UE group, the first UE 102a or the second UE 102b may transmit, to the network entity 104, the UE group-based beam report that includes information for the whole UE group. For example, the first UE 102a transmits 320 the UE group beam report to the network entity 104. FIG. 6 described UE group detection by the network entity 104, whereas FIGS. 7-8 show methods for implementing one or more aspects of FIG. 6. In particular, FIG. 7 shows an implementation by the UE 102 of the one or more aspects of FIG. 6. FIG. 8 shows an implementation by the network entity 104 of the one or more aspects of FIG. 6.

FIG. 7 illustrates a flowchart 700 of a method of wireless communication at a UE 102. For example, the UE 102 transmits 702 UE capability report on UE group beam report with network-based UE grouping detection. Referring to FIG. 6, the UE 102 indicates 602, to the network entity 104, a UE capability on UE group-based beam report based on network detection of a UE group.

The UE 102 receives 704 control signaling configuring at least one beam report configuration based on a set of CMRs. For example, referring to FIG. 6, the UE 102 receives 604, from the network entity 104, a beam report configuration for a set of CMRs.

The UE 102 receives 706 triggering control signaling that triggers the configured beam report. For example, referring to FIG. 6, the UE 102 receives 606, from the network entity 104, a triggering indication for a beam report.

The UE 102 receives 708 beams on the set of CMRs. For example, referring to FIG. 6, the UE 102 measures beams from the network entity 104 on the set of CMRs 608 that are configured by the network entity 104.

The UE 102 transmits 710 a beam report based on the received beams on the set of CMRs. For example, referring to FIG. 6, the UE 102 transmits 610, to the network entity 104, a beam report for the measured set of CMRs 608.

The UE 102 receives 718 UE group update control signaling. For example, referring to FIG. 6, the UE 102 receives 318 UE group update signaling from the network entity 104.

FIG. 8 illustrates a flowchart 800 of a method of wireless communication at a network entity 104. For example, the network entity 104 receives 802, from a first UE and a second UE, a UE capability report on UE group beam report with network-based UE grouping detection. Referring to FIG. 6, the network entity 104 receives 602, from the UEs 102a-102b, a UE capability on UE group-based beam report based on network detection of a UE group.

The network entity 104 transmits 804 first control signaling to the first UE and second control signaling to the second UE configuring the first UE and the second UE with at least one beam report configuration based on a set of CMRs. For example, referring to FIG. 6, the network entity 104 transmits 604a-604b, to the UEs 102a-102b, a beam report configuration for a set of CMRs.

The network entity 104 transmits 806 first triggering control signaling to the first UE and second triggering control signaling to the second UE that triggers the configured beam reports. For example, referring to FIG. 6, the network entity 104 transmits 606a-606b, to the UEs 102a-102b, a triggering indication for a beam report.

The network entity 104 transmits 808 beams on the set of CMRs. For example, referring to FIG. 6, the network entity 104 transmits beams to the UEs 102a-102b on the set of CMRs 608 configured by the network entity 104.

The network entity 104 receives 810 a first beam report from the first UE and a second beam report from the second UE based on the set of CMRs. For example, referring to FIG. 6, the network entity 104 receives 610, from the UEs 102a-102b, beam reports for the measured set of CMRs 608.

The network entity 104 determines 814 a UE grouping status based on the first beam report and the second beam report. For example, referring to FIG. 6, the network entity 104 determines 614 a UE grouping status based on the beam reports received 610 from the UEs 102a-102b.

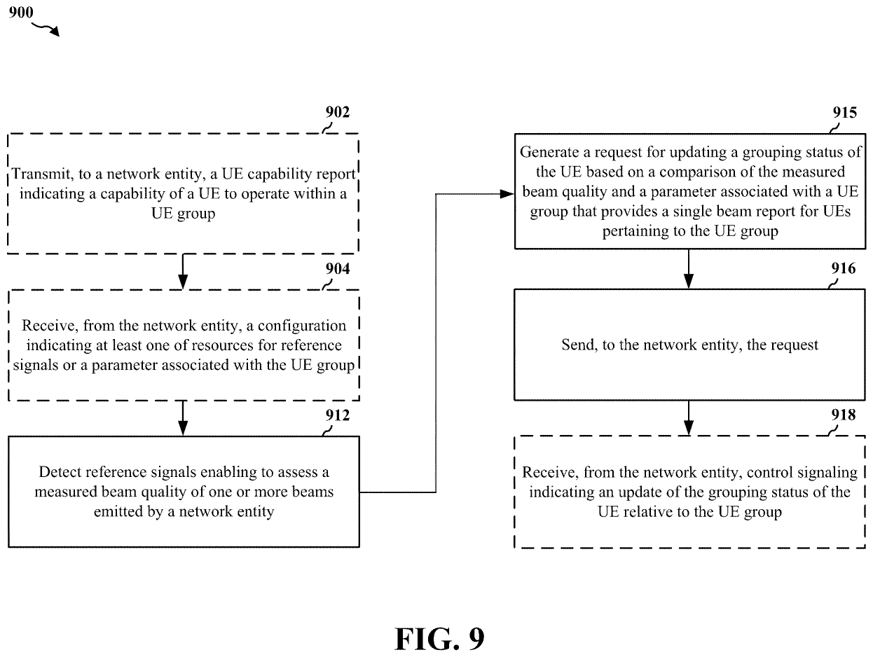

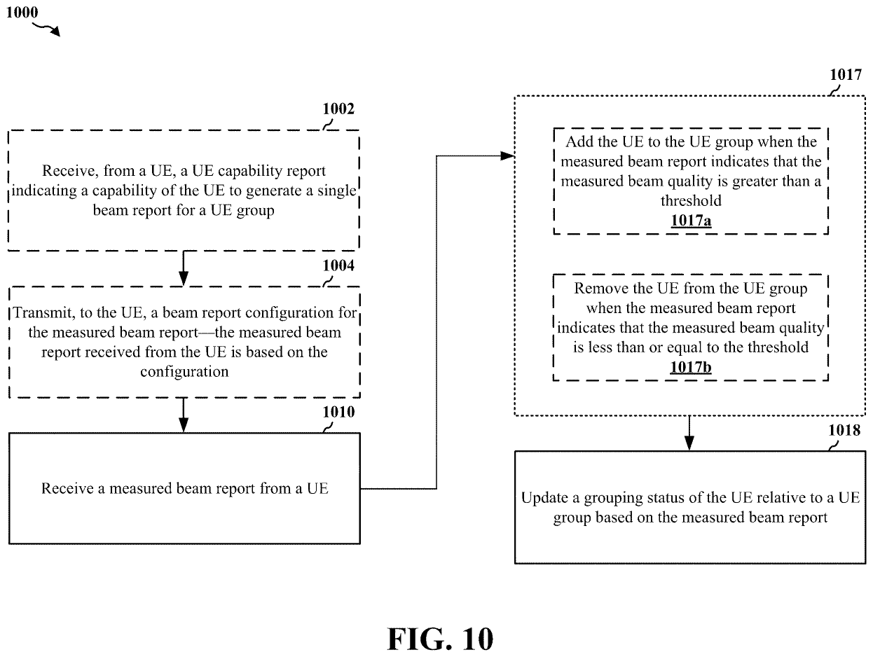

The network entity 104 transmits 818 first UE group update control signaling to the first UE and second UE group update control signaling to the second UE. For example, referring to FIG. 6, the network entity 104 transmits 318/618 UE group update signaling to the UEs 102a-102b. FIGS. 2A-8 illustrate procedures for sending 320, to a network entity 104, a single beam report for a group of UEs. FIGS. 9-10 show methods for implementing one or more aspects of FIGS. 2A-8. In particular, FIG. 8 shows an implementation by the UE 102 of the one or more aspects of FIGS. 2A-8. FIG. 10 shows an implementation by the network entity 104 of the one or more aspects of FIGS. 2A-8.

FIG. 9 illustrates a flowchart 900 of a method of wireless communication at a UE. With reference to FIGS. 2A-8 and 11, the method may be performed by the UE 102, the UE apparatus 1102, etc., which may include the memory 1126′, 1106′, 1116, and which may correspond to the entire UE 102 or the entire UE apparatus 1102, or a component of the UE 102 or the UE apparatus 1102, such as the wireless baseband processor 1126 and/or the application processor 1106.

The UE 102 transmits 902, to a network entity, a UE capability report indicating a capability of a UE to operate within a UE group. For example, referring to FIG. 3, the UE 102 transmits 302, to the network entity 104, the UE capability on UE-group based beam reporting based on UE group detection at the UE 102. Referring to FIG. 6, the UE 102 transmits 602, to the network entity 104, the UE capability on UE-group based beam reporting based on network detection of a UE group.

The UE 102 receives 904, from the network entity, a configuration indicating at least one of resources for reference signals or a parameter associated with the UE group. For example, referring to FIG. 3, the UE 102 receives 304, from the network entity 104, a beam report configuration for UE group detection. Referring to FIG. 6, the UE 102 receives 604, from the network entity 104, a beam report configuration for a set of CMRs.

The UE 102 detects 912 reference signals enabling to assess a measured beam quality of one or more beams emitted by a network entity. For example, referring to FIG. 3, the UE 102 detects/receives 312a-312n one or more reference signals for UE group detection.

The UE 102 generates 915 a request for updating a grouping status of the UE based on a comparison of the measured beam quality and a parameter associated with a UE group that provides a single beam report for UEs pertaining to the UE group. For example, referring to FIG. 3, the UE 102 generates a UE status report/update for joining or leaving the UE group after determining 314 whether to join or leave the UE group based on the received reference signals 312a-312n and the received configuration 304a.

The UE 102 sends 916, to the network entity, the request. For example, referring to FIG. 3, the UE 102 transmits 316, to the network entity 104, a UE status report/update for joining or leaving the UE group.

The UE 102 receives 918, from the network entity, control signaling indicating an update of the grouping status of the UE relative to the UE group. For example, referring to FIG. 3, the UE 102 receives 318, from the network entity 104, the UE group update signaling. FIG. 9 describes a method from a UE-side of a wireless communication link, whereas FIG. 10 describes a method from a network-side of the wireless communication link.

FIG. 10 is a flowchart 1000 of a method of wireless communication at a network entity. With reference to FIGS. 2A-8 and 12, the method may be performed by one or more network entities 104, which may correspond to a base station or a unit of the base station, such as the RU 106, the DU 108, the CU 110, an RU processor 1206, a DU processor 1226, a CU processor 1246, etc. The one or more network entities 104 may include memory 1206′/1226′/1246′, which may correspond to an entirety of the one or more network entities 104, or a component of the one or more network entities 104, such as the RU processor 1206, the DU processor 1226, or the CU processor 1246.

The network entity 104 receives 1002, from a UE, a UE capability report indicating a capability of the UE to generate a single beam report for a UE group. For example, referring to FIG. 3, the network entity 104 receives 302, from a UE 102, a UE capability on UE-group based beam reporting based on UE group detection at the UE 102. Referring to FIG. 6, network entity 104 receives 602, from a UE 102, a UE capability on UE-group based beam reporting based on network detection of a UE group.

The network entity 104 transmits 1004, to the UE, a beam report configuration for the measured beam report-the measured beam report received from the UE is based on the configuration. For example, referring to FIG. 3, the network entity 104 transmits 304, to a UE 102, a beam report configuration for UE group detection, the UE status report/update being received 316 based on the configuration. Referring to FIG. 6, the network entity 104 transmits 604, to a UE 102, a beam report configuration for a set of CMRs 608, the beam report for the measured set of CMRs 608 being received 610 from the UE 102 based on the configuration.

The network entity 104 receives 1016 a measured beam report from a UE. For example, referring to FIG. 3, the network entity 104 receives 316, from the UE 102, the UE status report/update. Referring to FIG. 6, the network entity 104 receives 610, from the UE 102, the beam report for the measured set of CMRs 608.

The network entity 104 may adjust 1017 the UE group responsive to receiving 1016 the measured beam report. For example, the network entity 104 adds 1017a the UE to the UE group when the measured beam report indicates that the measured beam quality is greater than a threshold or removes 1017b the UE from the UE group when the measured beam report indicates that the measured beam quality is less than or equal to the threshold. For example, referring to FIGS. 3 and 6, the network entity 104 adds or removes the UE 102 from the UE group via the UE group update signaling transmitted 318 to the UE 102.

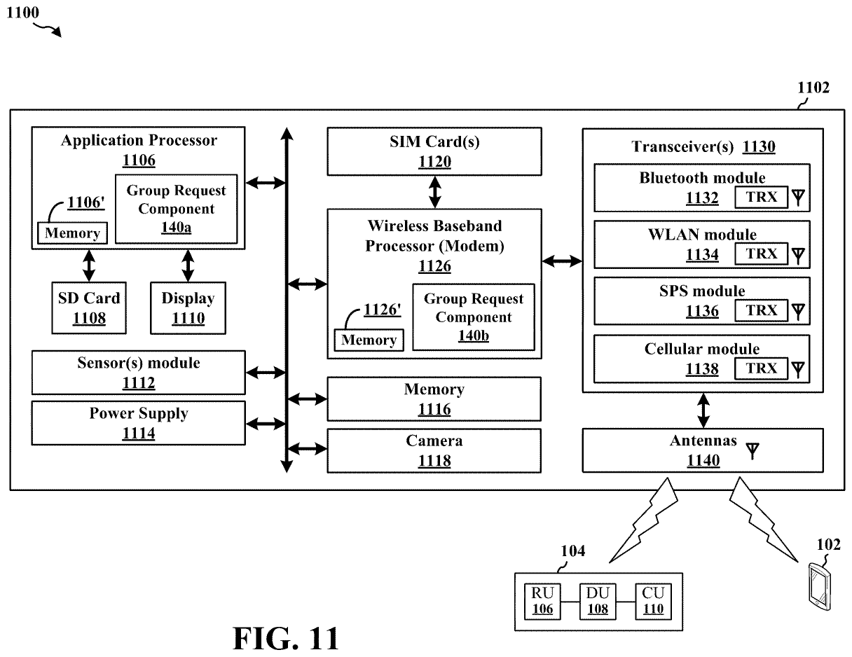

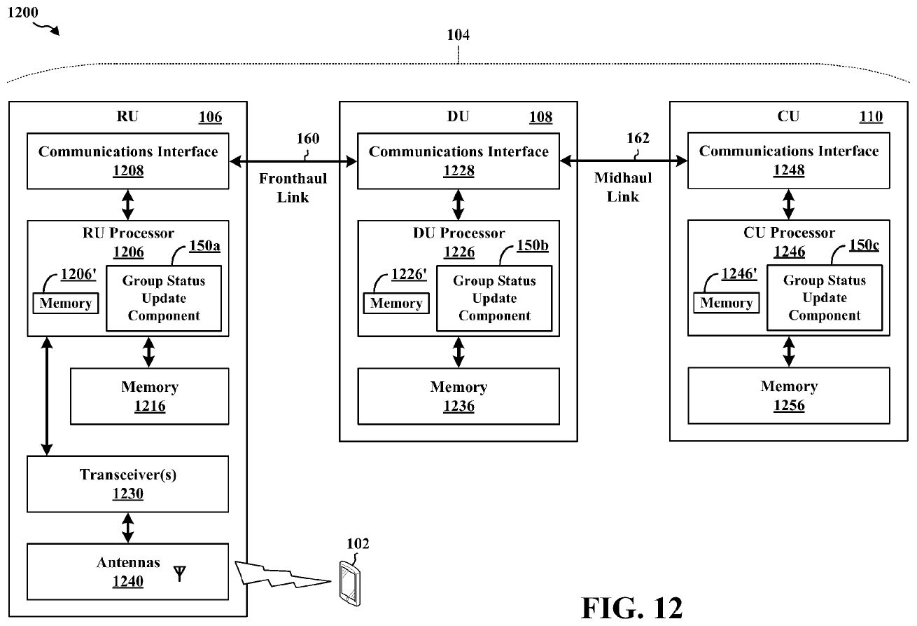

The network entity 104 updates 1018 a grouping status of the UE relative to a UE group based on the measured beam report. For example, referring to FIGS. 3 and 6, the network entity 104 transmits 318, to the UE 102, UE group update signaling to update the UE group based on the report received 316, 610 from the UE 102. A UE apparatus 1102, as described in FIG. 11, may perform the method of flowchart 900. The one or more network entities 104, as described in FIG. 12, may perform the method of flowchart 1000.

FIG. 11 is a diagram 1100 illustrating an example of a hardware implementation for a UE apparatus 1102. The UE apparatus 1102 may be the UE 102, a component of the UE 102, or may implement UE functionality. The UE apparatus 1102 may include an application processor 1106, which may have on-chip memory 1106′. In examples, the application processor 1106 may be coupled to a secure digital (SD) card 1108 and/or a display 1110. The application processor 1106 may also be coupled to a sensor(s) module 1112, a power supply 1114, an additional module of memory 1116, a camera 1118, and/or other related components. For example, the sensor(s) module 1112 may control a barometric pressure sensor/altimeter, a motion sensor such as an inertial management unit (IMU), a gyroscope, accelerometer(s), a light detection and ranging (LIDAR) device, a radio-assisted detection and ranging (RADAR) device, a sound navigation and ranging (SONAR) device, a magnetometer, an audio device, and/or other technologies used for positioning.

The UE apparatus 1102 may further include a wireless baseband processor 1126, which may be referred to as a modem. The wireless baseband processor 1126 may have on-chip memory 1126′. Along with, and similar to, the application processor 1106, the wireless baseband processor 1126 may also be coupled to the sensor(s) module 1112, the power supply 1114, the additional module of memory 1116, the camera 1118, and/or other related components. The wireless baseband processor 1126 may be additionally coupled to one or more subscriber identity module (SIM) card(s) 1120 and/or one or more transceivers 1130 (e.g., wireless RF transceivers).

Within the one or more transceivers 1130, the UE apparatus 1102 may include a Bluetooth module 1132, a WLAN module 1134, an SPS module 1136 (e.g., GNSS module), and/or a cellular module 1138. The Bluetooth module 1132, the WLAN module 1134, the SPS module 1136, and the cellular module 1138 may each include an on-chip transceiver (TRX), or in some cases, just a transmitter (TX) or just a receiver (RX). The Bluetooth module 1132, the WLAN module 1134, the SPS module 1136, and the cellular module 1138 may each include dedicated antennas and/or utilize antennas 1140 for communication with one or more other nodes. For example, the UE apparatus 1102 can communicate through the transceiver(s) 1130 via the antennas 1140 with another UE 102 (e.g., sidelink communication) and/or with a network entity 104 (e.g., uplink/downlink communication), where the network entity 104 may correspond to a base station or a unit of the base station, The wireless baseband processor 1126 and the application processor 1106 may each include a computer-readable medium/memory 1126′, 1106′, respectively. The additional module of memory 1116 may also be considered a computer-readable medium/memory. Each computer-readable medium/memory 1126′, 1106′, 1116 may be non-transitory. The wireless baseband processor 1126 and the application processor 1106 may each be responsible for general processing, including execution of software stored on the computer-readable medium/memory 1126′, 1106′, 1116. The software, when executed by the wireless baseband processor 1126/application processor 1106, causes the wireless baseband processor 1126/application processor 1106 to perform the various functions described herein. The computer-readable medium/memory may also be used for storing data that is manipulated by the wireless baseband processor 1126/application processor 1106 when executing the software. The wireless baseband processor 1126/application processor 1106 may be a component of the UE 102. The UE apparatus 1102 may be a processor chip (e.g., modem and/or application) and include just the wireless baseband processor 1126 and/or the application processor 1106. In other examples, the UE apparatus 1102 may be the entire UE 102 and include the additional modules of the apparatus 1102.

As discussed, the group request component 140 is configured to detect reference signals enabling to assess a measured beam quality of one or more beams emitted by a network entity; generate a request for updating a grouping status of the UE based on a comparison of the measured beam quality and a parameter associated with a UE group that provides a single beam report for UEs pertaining to the UE group, to the network entity; and send, to the network entity, the request. The group request component 140 may be within the application processor 1106 (e.g., at 140a), the wireless baseband processor 1126 (e.g., at 140b), or both the application processor 1106 and the wireless baseband processor 1126. The group request component 140a-140b may be one or more hardware components specifically configured to carry out the stated processes/algorithm, implemented by one or more processors configured to perform the stated processes/algorithm, stored within a computer-readable medium for implementation by the one or more processors, or a combination thereof.

The UE apparatus 1102 may include a variety of components configured for various functions. In examples, the UE apparatus 1102, and in particular the wireless baseband processor 1126 and/or the application processor 1106, includes means for detecting reference signals enabling to assess a measured beam quality of one or more beams emitted by a network entity; means for generating a request for updating a grouping status of the UE based on a comparison of the measured beam quality and a parameter associated with a UE group that provides a single beam report for UEs pertaining to the UE group, to the network entity; and means for sending, to the network entity, the request. The UE apparatus 1102 further includes means for receiving, from the network entity, a configuration indicating at least one of resources for the reference signals or the parameter associated with the UE group. The UE apparatus 1102 further includes means for transmitting, to the network entity, a UE capability report indicating a capability of the UE to operate within the UE group. The UE apparatus 1102 further includes means for receiving, from the network entity, control signaling indicating an update of the grouping status of the UE relative to the UE group. The means may be the group request component 140a-140b of the UE apparatus 1102 configured to perform the functions recited by the means.

FIG. 12 is a diagram 1200 illustrating an example of a hardware implementation for one or more network entities 104. The one or more network entities 104 may be a base station, a component of a base station, or may implement base station functionality. The one or more network entities 104 may include, or may correspond to, at least one of the RU 106, the DU, 108, or the CU 110. The CU 110 may include a CU processor 1246, which may have on-chip memory 1246′. In some aspects, the CU 110 may further include an additional module of memory 1256 and/or a communications interface 1248, both of which may be coupled to the CU processor 1246. The CU 110 can communicate with the DU 108 through a midhaul link 162, such as an F1 interface between the communications interface 1248 of the CU 110 and a communications interface 1228 of the DU 108.

The DU 108 may include a DU processor 1226, which may have on-chip memory 1226′. In some aspects, the DU 108 may further include an additional module of memory 1236 and/or the communications interface 1228, both of which may be coupled to the DU processor 1226. The DU 108 can communicate with the RU 106 through a fronthaul link 160 between the communications interface 1228 of the DU 108 and a communications interface 1208 of the RU 106.

The RU 106 may include an RU processor 1206, which may have on-chip memory 1206′. In some aspects, the RU 106 may further include an additional module of memory 1216, the communications interface 1208, and one or more transceivers 1230, all of which may be coupled to the RU processor 1206. The RU 106 may further include antennas 1240, which may be coupled to the one or more transceivers 1230, such that the RU 106 can communicate through the one or more transceivers 1230 via the antennas 1240 with the UE 102.

The on-chip memory 1206′, 1226′, 1246′ and the additional modules of memory 1216, 1236, 1256 may each be considered a computer-readable medium/memory. Each computer-readable medium/memory may be non-transitory. Each of the processors 1206, 1226, 1246 is responsible for general processing, including execution of software stored on the computer-readable medium/memory. The software, when executed by the corresponding processor(s) 1206, 1226, 1246 causes the processor(s) 1206, 1226, 1246 to perform the various functions described herein. The computer-readable medium/memory may also be used for storing data that is manipulated by the processor(s) 1206, 1226, 1246 when executing the software. In examples, the group status update component 150 may sit at any of the one or more network entities 104, such as at the CU 110; both the CU 110 and the DU 108; each of the CU 110, the DU 108, and the RU 106; the DU 108; both the DU 108 and the RU 106; or the RU 106.

As discussed, the group status update component 150 is configured to receive a measured beam report from a UE; and update a grouping status of the UE relative to a UE group based on the measured beam report, the network entity receiving a single beam report for UEs in the UE group. The group status update component 150 may be within one or more processors of the one or more network entities 104, such as the RU processor 1206 (e.g., at 150a), the DU processor 1226 (e.g., at 150b), and/or the CU processor 1246 (e.g., at 150c). The group status update component 150a-150c may be one or more hardware components specifically configured to carry out the stated processes/algorithm, implemented by one or more processors 1206, 1226, 1246 configured to perform the stated processes/algorithm, stored within a computer-readable medium for implementation by the one or more processors 1206, 1226, 1246, or a combination thereof.

The one or more network entities 104 may include a variety of components configured for various functions. In examples, the one or more network entities 104 include means for receiving a measured beam report from a UE; and means for updating a grouping status of the UE relative to a UE group based on the measured beam report, the network entity receiving a single beam report for UEs in the UE group. The means for updating the grouping status is further configured to remove the UE from the UE group when the measured beam report indicates that a measured beam quality is less than or equal to a threshold, and add the UE to the UE group when the measured beam report indicates that the measured beam quality is greater than the threshold. The one or more network entities 104 further include means for receiving, from the UE, a UE capability report indicating a capability of the UE to generate the single beam report for the UE group. The one or more network entities 104 further include means for transmitting, to the UE, a beam report configuration for the measured beam report, the measured beam report received from the UE being based on the configuration. The one or more network entities 104 further include means for updating a periodicity of the measurement cycle. The means may be the group status update component 150a-150c of the one or more network entities 104 configured to perform the functions recited by the means.

The specific order or hierarchy of blocks in the processes and flowcharts disclosed herein is an illustration of example approaches. Hence, the specific order or hierarchy of blocks in the processes and flowcharts may be rearranged. Some blocks may also be combined or deleted. Dashed lines may indicate optional elements of the diagrams. The accompanying method claims present elements of the various blocks in an example order, and are not limited to the specific order or hierarchy presented in the claims, processes, and flowcharts.

The detailed description set forth herein describes various configurations in connection with the drawings and does not represent the only configurations in which the concepts described herein may be practiced. The detailed description includes specific details for the purpose of providing a thorough explanation of various concepts. However, these concepts may be practiced without these specific details. In some instances, well known structures and components are shown in block diagram form in order to avoid obscuring such concepts.

Aspects of wireless communication systems, such as telecommunication systems, are presented with reference to various apparatuses and methods. These apparatuses and methods are described in the following detailed description and are illustrated in the accompanying drawings by various blocks, components, circuits, processes, call flows, systems, algorithms, etc. (collectively referred to as “elements”). These elements may be implemented using electronic hardware, computer software, or combinations thereof. Whether such elements are implemented as hardware or software depends upon the particular application and design constraints imposed on the overall system.

An element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems-on-chip (SoC), baseband processors, field programmable gate arrays (FPGAs), programmable logic devices (PLDs), state machines, gated logic, discrete hardware circuits, and other similar hardware configured to perform the various functionality described herein. One or more processors in the processing system may execute software, which may be referred to as software, firmware, middleware, microcode, hardware description language, or otherwise. Software shall be construed broadly to mean instructions, instruction sets, code, code segments, program code, programs, subprograms, software components, applications, software applications, software packages, routines, subroutines, objects, executables, threads of execution, procedures, functions, or any combination thereof.

If the functionality described herein is implemented in software, the functions may be stored on, or encoded as, one or more instructions or code on a computer-readable medium, such as a non-transitory computer-readable storage medium. Computer-readable media includes computer storage media and can include a random-access memory (RAM), a read-only memory (ROM), an electrically erasable programmable ROM (EEPROM), optical disk storage, magnetic disk storage, other magnetic storage devices, combinations of these types of computer-readable media, or any other medium that can be used to store computer executable code in the form of instructions or data structures that can be accessed by a computer. Storage media may be any available media that can be accessed by a computer.

Aspects, implementations, and/or use cases described herein may be implemented across many differing platform types, devices, systems, shapes, sizes, and packaging arrangements. For example, the aspects, implementations, and/or use cases may come about via integrated chip implementations and other non-module-component based devices, such as end-user devices, vehicles, communication devices, computing devices, industrial equipment, retail/purchasing devices, medical devices, artificial intelligence (AI)-enabled devices, machine learning (ML)-enabled devices, etc. The aspects, implementations, and/or use cases may range from chip-level or modular components to non-modular or non-chip-level implementations, and further to aggregate, distributed, or original equipment manufacturer (OEM) devices or systems incorporating one or more techniques described herein.

Devices incorporating the aspects and features described herein may also include additional components and features for the implementation and practice of the claimed and described aspects and features. For example, transmission and reception of wireless signals necessarily includes a number of components for analog and digital purposes, such as hardware components, antennas, RF-chains, power amplifiers, modulators, buffers, processor(s), interleavers, adders/summers, etc. Techniques described herein may be practiced in a wide variety of devices, chip-level components, systems, distributed arrangements, aggregated or disaggregated components, end-user devices, etc., of varying configurations.

The description herein is provided to enable a person skilled in the art to practice the various aspects described herein. Various modifications to these aspects will be readily apparent to those skilled in the art, and the generic principles defined herein may be applied to other aspects. Thus, the claims are not limited to the aspects described herein, but are to be interpreted in view of the full scope of the present description consistent with the language of the claims.

Reference to an element in the singular does not mean “one and only one” unless specifically stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The terms “may”, “might”, and “can”, as used herein, often carry certain connotations. For example, “may” refers to a permissible feature that may or may not occur, “might” refers to a feature that probably occurs, and “can” refers to a capability (e.g., capable of). The phrase “For example” often carries a similar connotation to “may” and, therefore, “may” is sometimes excluded from sentences that include “for example” or other similar phrases.

Unless specifically stated otherwise, the term “some” refers to one or more. Combinations such as “at least one of A, B, or C” or “one or more of A, B, or C” include any combination of A, B, and/or C, such as A and B, A and C, B and C, or A and B and C, and may include multiples of A, multiples of B, and/or multiples of C, or may include A only, B only, or C only. Sets should be interpreted as a set of elements where the elements number one or more.

Unless otherwise specifically indicated, ordinal terms such as “first” and “second” do not necessarily imply an order in time, sequence, numerical value, etc., but are used to distinguish between different instances of a term or phrase that follows each ordinal term. Reference numbers, as used in the specification and figures, are sometimes cross-referenced among drawings to denote same or similar features. A feature that is exactly the same in multiple drawings may be labeled with the same reference number in the multiple drawings. A feature that is similar among the multiple drawings, but not exactly the same, may be labeled with reference numbers that have different leading numbers, but have one or more of the same trailing numbers (e.g., 206, 306, 406, etc., may refer to similar features in the drawings). Sometimes an “X” is used to universally denote multiple variations of a feature. For instance, “X06” can universally refer to all reference numbers that end in “06” (e.g., 206, 306, 406, etc.).

Structural and functional equivalents to elements of the various aspects described herein that are known or later come to be known to those of ordinary skill in the art are expressly incorporated herein by reference and are encompassed by the claims. The words “module,” “mechanism,” “element,” “device,” and the like may not be a substitute for the word “means.” As such, no claim element is to be construed as a means plus function unless the element is expressly recited using the phrase “means for.” As used herein, the phrase “based on” shall not be construed as a reference to a closed set of information, one or more conditions, one or more factors, or the like. In other words, the phrase “based on A”, where “A” may be information, a condition, a factor, or the like, shall be construed as “based at least on A” unless specifically recited differently.

The following examples are illustrative only and may be combined with other examples or teachings described herein, without limitation.
Example 1 is a method of wireless communication at a UE, including: detecting reference signals enabling to assess a measured beam quality of one or more beams emitted by a network entity; generating a request for updating a grouping status of the UE based on a comparison of the measured beam quality and a parameter associated with a UE group that provides a single beam report for UEs pertaining to the UE group, to the network entity; and sending, to the network entity, the request.
Example 2 may be combined with example 1 and further includes receiving, from the network entity, a configuration indicating at least one of resources for the reference signals or the parameter associated with the UE group.
Example 3 may be combined with any of Examples 1-2 and includes that the UE receives the reference signals from a second UE.
Example 4 may be combined with any of Examples 1-3 and further includes transmitting, to the network entity, a UE capability report indicating a capability of the UE to operate within the UE group.
Example 5 may be combined with Example 4 and includes that the UE capability report further indicates a maximum number of configured reference signals for the detecting the reference signals to assess the measured beam quality.
Example 6 may be combined with any of Examples 1-5 and includes that a UE status change for the UE joining or leaving the UE group, and one of: a first number of consecutively detected measurement instances of the reference signals for which the assessed measured beam quality is greater than a first threshold, or a second number of consecutively detected measurement instances of the reference signals for which the assessed measured beam quality is less than a second threshold.
Example 7 may be combined with Example 6 and includes that the request includes the first number if the UE status change corresponds to the UE joining the UE group, and the request includes the second number if the UE status change corresponds to the UE leaving the UE group.
Example 8 may be combined with any of Examples 1-7 and includes that the detecting occurs within a beam quality detection interval, the beam quality detection interval being predefined or configured by the network entity.
Example 9 may be combined with any of Examples 1-8 and includes that the detecting comprises detecting a change in the measured beam quality.
Example 10 may be combined with any of Examples 1-9 and further includes receiving, from the network entity, control signaling indicating an update of the grouping status of the UE relative to the UE group, the grouping status being whether the UE is within the UE group or outside of the UE group.
Example 11 is a method of wireless communication at a network entity, including: receiving a measured beam report from a user equipment (UE); and updating a grouping status of the UE relative to a UE group based on the measured beam report, the network entity receiving a single beam report for UEs in the UE group.
Example 12 may be combined with Example 11 and further includes receiving, from the UE, a UE capability report indicating a capability of the UE to generate the single beam report for the UE group.
Example 13 may be combined with any of Examples 11-12 and further includes transmitting, to the UE, a beam report configuration for the measured beam report, the measured beam report received from the UE being then based on the configuration.
Example 14 may be combined with Example 13 and include that the beam report configuration indicates a measurement cycle for generating the measured beam report.
Example 15 may be combined with Example 14 and include that the measurement cycle indicates a DRX-M, the beam report configuration further indicating at least one of: an activation duration for the DRX-M, or a deactivation duration for the DRX-M.
Example 16 may be combined with any of Examples 14-15 and further include updating a periodicity of the measurement cycle.
Example 17 may be combined with any of Examples 11-16 and include that the updating of the grouping status, further includes: removing the UE from the UE group when the measured beam report indicates that a measured beam quality is less than or equal to a threshold, and adding the UE to the UE group when the measured beam report indicates that the measured beam quality is greater than the threshold.
Example 18 is an apparatus for wireless communication for implementing a method as in any of examples 1-17.
Example 19 is an apparatus for wireless communication including means for implementing a method as in any of examples 1-17.
Example 20 is a non-transitory computer-readable medium storing computer executable code, the code when executed by a processor causes the processor to implement a method as in any of examples 1-17.

What is claimed is:

1. A method of wireless communication at a user equipment (UE), the method comprising:
detecting reference signals enabling to assess a measured beam quality of one or more beams emitted by a network entity;
generating a request for updating a grouping status of the UE based on a comparison of the measured beam quality and a parameter associated with a UE group that provides a single beam report for UEs pertaining to the UE group; and
sending, to the network entity, the request.

2. The method of claim 1, further comprising:
receiving, from the network entity, a configuration indicating at least one of resources for the reference signals or the parameter associated with the UE group.

3. The method of claim 1, wherein the UE receives the reference signals from a second UE.

4. The method of claim 1, further comprising:
transmitting, to the network entity, a UE capability report indicating a capability of the UE to operate within the UE group.

5. The method of claim 4, wherein the UE capability report further indicates a maximum number of configured reference signals for the detecting the reference signals to assess the measured beam quality.

6. The method of claim 1, wherein the request includes:
a UE status change for the UE joining or leaving the UE group, and one of:
a first number of consecutively detected measurement instances of the reference signals for which the assessed measured beam quality is greater than a first threshold, or
a second number of consecutively detected measurement instances of the reference signals for which the assessed measured beam quality is less than a second threshold.

7. The method of claim 6, wherein the request includes the first number if the UE status change corresponds to the UE joining the UE group, and
the request includes the second number if the UE status change corresponds to the UE leaving the UE group.

8. The method of claim 1, wherein the detecting occurs within a beam quality detection interval, the beam quality detection interval being predefined or configured by the network entity.

9. The method of claim 1, wherein the detecting comprises detecting a change in the measured beam quality.

10. The method of claim 1, further comprising:
receiving, from the network entity, control signaling indicating an update of the grouping status of the UE relative to the UE group, the grouping status being whether the UE is within the UE group or outside of the UE group.

11. A method of wireless communication at a network entity, comprising:
receiving a measured beam report from a user equipment (UE); and
transmitting control signaling indicating an update of a grouping status of the UE relative to a UE group based on the measured beam report.

12. The method of claim 11, further comprising:
receiving, from the UE, a UE capability report indicating a capability of the UE to generate single beam report for the UE group.

13. The method of claim 11, further comprising:
transmitting, to the UE, a beam report configuration for the measured beam report, the measured beam report received from the UE being based on the configuration.

14. The method of claim 13, wherein the beam report configuration indicates a measurement cycle for generating the measured beam report.

15. The method of claim 14, wherein the measurement cycle indicates a discontinuous reception for measurement (DRX-M) the beam report configuration further indicating at least one of:
an activation duration for the DRX-M, or
a deactivation duration for the DRX-M.

16. The method of claim 14, further comprising:
updating a periodicity of the measurement cycle.

17. The method of claim 11, wherein the updating of the grouping status, comprises:
removing the UE from the UE group when the measured beam report indicates that a measured beam quality is less than or equal to a threshold, and
adding the UE to the UE group when the measured beam report indicates that the measured beam quality is greater than the threshold.

18. An apparatus for wireless communication at a user equipment (UE), comprising:
a transceiver;
a memory; and
a processor coupled to the memory and the transceiver, the processor configured to:
detect reference signals enabling to assess a measured beam quality of one or more beams emitted by a network entity;
generate a request for updating a grouping status of the UE based on a comparison of the measured beam quality and a parameter associated with a UE group that provides a single beam report for UEs pertaining to the UE group; and
send, to the network entity, the request.

19. The apparatus of claim 18, wherein the processor configured to:
receive, from the network entity, a configuration indicating at least one of resources for the reference signals or the parameter associated with the UE group.

20. The apparatus of claim 18, wherein the processor configured to:
transmit, to the network entity, a UE capability report indicating a capability of the UE to operate within the UE group.
